(19) United States
(12) Patent Application Publication
(10) Pub. No.: US 2026/0303941 A1
(43) Pub. Date: Oct. 1, 2026

(54) Multiwavelength flood projector

(71) Applicant: APPLE INC., Cupertino, CA (US)

(72) Inventors: Yuval Tsur, Herzliya (IL); Shay Keren-Zur, Tel Aviv (IL); Refael Della Pergola, Jerusalem (IL); Roei Remez, Tel Aviv (IL); Assaf Avraham, Givatayim (IL)

(21) Appl. No.: 19/432,947

(22) Filed: Dec. 25, 2025

Related U.S. Application Data
(60) Provisional application No. 63/778,494, filed on Mar. 27, 2025.

(51) Int. Cl. H04N 23/56; G03B 15/02

(52) U.S. Cl. CPC H04N 23/56; G03B 15/02

(57) ABSTRACT

An illumination projector includes at least first and second emitters configured to emit respective first and second beams of coherent optical radiation at different, respective first and second wavelengths. Projection optics mounted over the at least first and second emitters combine the first and second beams into a cone of flood illumination having an angular extent of at least 30°.

### CROSS-REFERENCE TO RELATED APPLICATION

This application claims the benefit of U.S. Provisional Patent Application 63/778,494, filed Mar. 27, 2025, which is incorporated herein by reference.

### FIELD OF THE INVENTION

The present invention relates generally to optoelectronic devices, and particularly to sources of optical radiation.

### BACKGROUND

Various sorts of portable computing devices (referred to collectively as “portable devices” in the description), such as smartphones, augmented reality (AR) devices, virtual reality (VR) devices, smart watches and smart glasses, comprise compact sources of optical radiation, commonly termed “illumination projectors.” (The terms “optical rays,” “optical radiation” and “light,” as used in the present description and in the claims, refer generally to any and all of visible, infrared, and ultraviolet radiation.) For example, the illumination projector may comprise a light source that emits flood illumination, illuminating a target region with broad and uniform illumination for the purpose of feature illumination and recognition. Another source may, for example, project patterned radiation so as to illuminate the target region with a pattern of multiple spots for three-dimensional (3D) mapping of the region.

Portable devices also commonly comprise a display unit, comprising a display panel and a protective cover glass, for displaying various information to the user of the device. For maximizing the area of the display unit within the portable device, illumination projectors may be located under the display unit.

Optical metasurfaces are thin layers that comprise a two-dimensional pattern of structures, having dimensions (pitch and thickness) less than the target wavelength of the radiation with which the metasurface is designed to interact. Optical elements comprising optical metasurfaces are referred to herein as “metasurface optical elements” (MOEs).

U.S. Pat. No. 12,123,589, whose disclosure is incorporated herein by reference, describes an optoelectronic apparatus, which includes a semiconductor substrate and an array of emitters disposed on the semiconductor substrate and configured to emit beams of optical radiation having respective chief rays. An optical diffuser is mounted over the semiconductor substrate and configured to diffuse the beams. Microlenses are disposed between the semiconductor substrate and the optical diffuser in respective alignment with the emitters and configured to steer the beams at different, respective angles, which are selected so that at least some of the chief rays cross one another before passing through the diffuser.

U.S. Patent Application Publication 2024/0094437, whose disclosure is incorporated herein by reference, describes an optoelectronic apparatus, which includes an array of emitters configured to emit beams of optical radiation. An optical substrate is mounted over the array. An optical metasurface is disposed on the optical substrate and configured to collimate and split each of the emitted beams into a respective group of collimated sub-beams, and to direct the collimated sub-beams toward a target to form a pattern of spots on the target.

U.S. Patent Application Publication 2021/0364902, whose disclosure is incorporated herein by reference, describes an optoelectronic apparatus, which includes a heat sink, which is shaped to define a base, a first platform at a first elevation above the base, and a second platform alongside the first platform at a second elevation above the base, which is different from the first elevation. A first monolithic emitter array is mounted on the first platform and is configured to emit first optical beams. A second monolithic emitter array is mounted on the second platform and is configured to emit second optical beams. An optical element is configured to direct both the first and the second optical beams toward a target region.

### SUMMARY

Embodiments of the present invention that are described hereinbelow provide improved designs and methods of fabrication of sources of optical radiation.

There is therefore provided, in accordance with an embodiment of the invention, an illumination projector, which includes at least first and second emitters configured to emit respective first and second beams of coherent optical radiation at different, respective first and second wavelengths. Projection optics are mounted over the at least first and second emitters and configured to combine the first and second beams into a cone of flood illumination having an angular extent of at least 30°.

In a disclosed embodiment, the at least two different wavelengths differ by an amount exceeding 3 nm.

In some embodiments, each of the first and second emitters includes at least one vertical-cavity surface-emitting laser (VCSEL). In one embodiment, the projector includes a microlens disposed over each VCSEL. Alternatively or additionally, the first and second emitters include respective first and second pluralities of VCSELs, and the projection optics are configured to apply different degrees of divergence to the coherent optical radiation emitted by the VCSELs in each of the first and second pluralities.

In some embodiments, the projection optics include at least one metasurface optical element (MOE). In a disclosed embodiment, the at least one MOE is configured to apply different, respective tilt angles to the first and second beams. Additionally or alternatively, the at least one MOE includes a single MOE having respective first and second optical zones for receiving the first and second beams.

In another embodiment, the projection optics include at least one diffractive optical element (DOE).

In some embodiments, the illumination projector includes at least a third emitter positioned adjacent to the first and second emitters and configured to emit a third beam of coherent radiation. Beamsplitting optics are configured to split the third beam into a pattern of structured light distributed across at least a part of the angular extent. In a disclosed embodiment, the beamsplitting optics and the projection optics are implemented in distinct, respective optical zones of a metasurface optical element (MOE).

There is also provided, in accordance with an embodiment of the invention, an optical system, including the illumination projector as described above, configured to project the flood illumination onto a field of view, and a camera positioned alongside the illumination projector and configured to capture images of the field of view under the flood illumination.

In a disclosed embodiment, the optical system includes a display panel, which is transparent at the first and second wavelengths, wherein the illumination projector and the camera are positioned behind the display panel so that the flood illumination is projected toward the field of view and the images of the field of view are captured through the display panel.

There is additionally provided, in accordance with an embodiment of the invention, a method for illumination, which includes driving at least first and second emitters to emit respective first and second beams of coherent optical radiation at different, respective first and second wavelengths. The first and second beams are combined and projected into a cone of flood illumination having an angular extent of at least 30°.

The present invention will be more fully understood from the following detailed description of the embodiments thereof, taken together with the drawings in which:

### BRIEF DESCRIPTION OF THE DRAWINGS

FIG. 1 is a schematic sectional view of an optical system, in accordance with an embodiment of the invention;

FIG. 2 is a schematic sectional view of a flood illuminator, in accordance with an embodiment of the invention;

FIG. 3 is a schematic sectional view of a flood illuminator, in accordance with another embodiment of the invention; and

FIGS. 4A and 4B are respective schematic sectional views of two flood illuminators, in accordance with embodiments of the invention.

### DETAILED DESCRIPTION OF EMBODIMENTS

Illumination projectors in some portable devices are located under the display unit of the device. The display unit typically comprises a display panel, such as an array of organic light-emitting diodes (OLED-array), and a thin protecting cover sheet of glass or other transparent material. The illumination projector may comprise both a flood projector, emitting a cone of uniform radiation over a broad area of a target, and a pattern projector, emitting an array of focused beams of radiation for illuminating the target with structured light, such as a pattern of discrete spots.

The flood and spot projectors may comprise sources of narrow-band coherent illumination, such as vertical-cavity surface-emitting lasers (VCSELs). As the cone of radiation emitted by the flood projector is transmitted through the display unit of the device, a portion of the radiation experiences two or more reflections at the interfaces between the different layers of the of the display. The reflections can interfere either constructively or destructively with the emitted radiation, depending on the wavelength and angle of the light rays as well as the layers'refractive indices and thicknesses. As a result of the interference, the intensity of the flood illumination on the target exhibits a spatial variation, for example in the form of brighter and darker rings. This kind of variation can have a deleterious effect on the feature recognition of the scene. The effect may become even more pronounced if the camera of the device is also located behind the display unit, as the light reflected from the scene to the camera experiences additional optical interference when passing through the display unit.

The embodiments of the present invention that are described herein alleviate the effects of optical interference in the display unit by providing two or more sources of optical radiation in the flood projector at different wavelengths, typically differing from each other by at least 3 nm. Projection optics, mounted over the sources of radiation, combine their respective emitted beams into a single beam and project it toward a target. The projection optics may widen the projected beam into a cone having large angular extent (30° or more).

The difference in wavelength between the beams emitted by the different sources gives rise to a shift in the locations of the respective spatial interference rings. Thus, for example in the case of two sources and two wavelengths, the dark rings due to the first wavelength can be arranged to coincide with the bright rings due to the second wavelength, thus smoothing out the intensity variations on the target as well as in images captured by the camera.

In some embodiments, the projection optics comprise an MOE, wherein the required functions of beam combination, deflection, and collimation or defocusing may be combined in a single element. Alternatively, the projection optics may comprise a diffractive optical element (DOE), comprising a two-dimensional pattern of structures having dimensions (pitch and thickness) comparable to or larger than the target wavelength of the optical radiation of the flood projector.

### Optical System

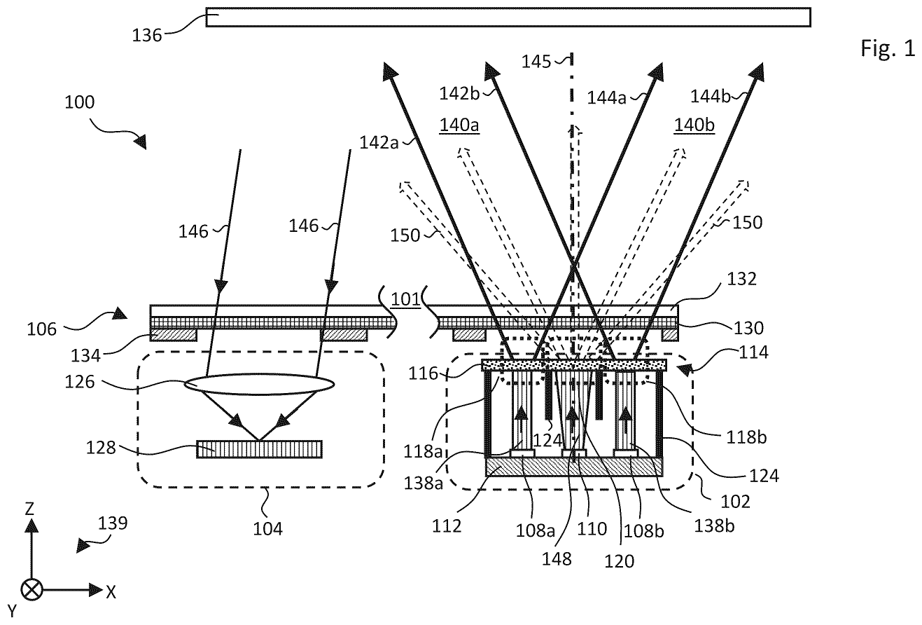

FIG. 1 is a schematic sectional view of an optical system 100, in accordance with an embodiment of the invention. Optical system 100 comprises an illumination projector 102 and a camera 104, both mounted under a display unit 106. (A break 101 indicates that projector 102 and camera 104 may be separated by a distance that is larger than the small separation shown in the figure.) Illumination projector 102 comprises two flood emitters 108a and 108b and a spot emitter 110 disposed on a substrate 112. (Alternative embodiments may comprise other numbers of flood and/or spot emitters.) Spot emitter 110 is positioned adjacent to flood emitters 108a and 108b, for example between the flood emitters as shown in FIG. 1.

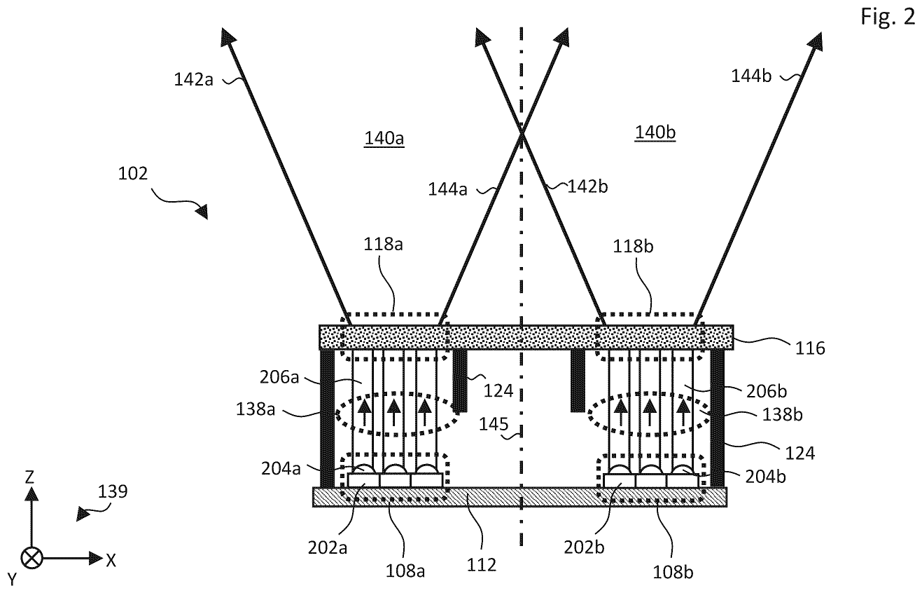

Each one of flood emitters 108a and 108b and spot emitter 110 comprises an array of vertical-cavity surface-emitting lasers (VCSELs). Flood emitters 108a and 108b, further detailed in FIG. 2 hereinbelow, emit optical radiation at two different respective wavelengths λₐ and λ_{b}. Projection optics 114, comprising an MOE 116, are mounted over emitters 108a, 108b and 110. MOE 116 comprises distinct optical zones 118a, 120 and 118b for receiving optical radiation respectively from emitters 108a, 110 and 108b, with the functions of the optical zones detailed hereinbelow. In the present embodiment, projection optics 114 comprise only one MOE 116. However, in alternative embodiments projection optics 114 may comprise multiple MOEs or MOEs combined with other refractive or diffractive optical lenses.

Illumination projector 102 further comprises a mechanical structure 124 configured to support projection optics 114 and to reduce crosstalk between the beams of optical radiation emitted by emitters 108a, 108b and 110. Mechanical structure 124 is fabricated of a material, such as metal or plastic, which is opaque at the wavelengths of radiation emitted by emitters 108a, 108b and 110.

Camera 104 comprises a lens 126 and an image sensor 128, wherein the lens focuses captured optical radiation onto the image sensor.

Display unit 106 comprises a display panel 130, such as an OLED array, and a cover glass 132 for protecting the display panel. Display unit 106 further comprises heat sinks 134 to absorb heat from display panel 130. Display unit 106, which for example functions as a display for a portable device, generally extends further than that shown in FIG. 1, but for the sake of clarity only the portion of the display panel in the vicinity of illumination projector 102 and camera 104 is shown.

Optical system 100 illuminates a target region 136 in a field of view of the system with flood illumination for feature recognition and/or with spot illumination for 3D mapping of the target region. For illuminating target region 136 with flood illumination, emitters 108a and 108b are driven to emit respective beams 138a and 138b of coherent optical radiation at two different wavelengths λₐ and λ_{b} in the Z-direction of Cartesian coordinates 139. Beams 138a and 138b impinge on respective optical zones 118a and 118b of MOE 116, which convert beams 138a and 138b into respective overlapping cones 140a and 140b of optical radiation. Cones 140a and 140b are projected through display unit 106 toward target region 136. Cone 140a is delineated by arrows 142a and 144a, and cone 140b is delineated by arrows 142b and 144b. Cones 140a and 140b are symmetrical with respect to an optical axis 145 of illuminator 102 and overlap so as to provide multi-wavelength flood illumination to target region 136 in the far field.

As previously described, emitting cones 140a and 140b at two different wavelengths λₐ and λ_{b} through display unit 106 mitigates nonuniformity due to optical interference effects in the illumination of target region 136. A portion of this illumination is reflected back toward camera 104 as reflected illumination 146. Before entering camera 104, reflected illumination 146 traverses display unit 106. As reflected illumination 146 also comprises the two different wavelengths λₐ and λ_{b}, possible interference effects in traversing display unit 106 toward camera 104 are further mitigated.

In an alternative embodiment, beams 138a and 138b may be focused by respective optical zones 118a and 118b of MOE 116.

For illuminating target region 136 with spot illumination for the purpose of 3D mapping, spot emitter 110 is driven to emit multiple beams 148 toward optical zone 120 of MOE 116. Optical zone 120 splits, deviates and focuses beams 148 to form multiple beams 150, which illuminate target region 136 with a pattern of spots. A portion of each spot is reflected back and captured by camera 104 for 3D mapping.

FIG. 2 is a schematic sectional view showing details of flood illuminator 102, in accordance with an embodiment of the invention. Spot emitter 110 is omitted for the sake of simplicity.

Flood emitters 108a and 108b are shown in FIG. 2 in detail that was omitted in FIG. 1: The VCSEL arrays of flood emitters 108a and 108b comprise respectively three emitters 202a and three emitters 202b in the X-direction, with microlenses 204a and 204b disposed over each respective emitter. (In alternative embodiments, the flood illuminator may comprise more or fewer than three emitters in each array.) Each emitter 202a and 202b emits a beam of optical radiation, which is collimated by its respective microlens 204a and 204b into a respective beam 206a and 206b. Thus, beams 206a emitted by emitters 202a of flood emitter 108a form collectively beam 138a (FIG. 1), which is converted by optical zone 118a of MOE 116 into cone 140a. Similarly, beams 206b emitted by emitters 202b of flood emitter 108b form collectively beam 138b, which is converted by optical zone 118b of MOE 116 into cone 140b.

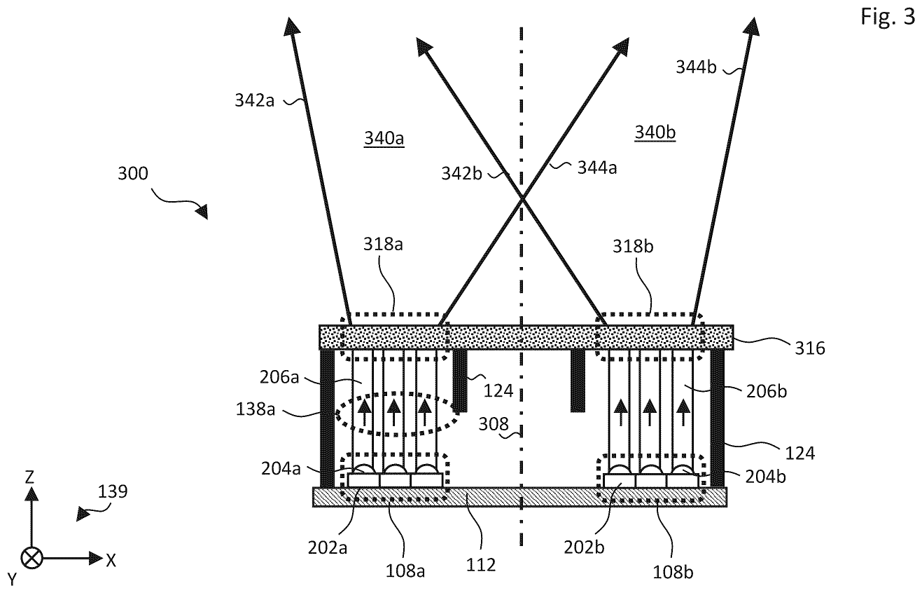

FIG. 3 is a schematic sectional view of a flood illuminator 300, in accordance with another embodiment of the invention. Flood illuminator 300 comprises similar emitters to those of flood illuminator 102 (FIG. 2) and may be used in its place in system 100 (FIG. 1), with the same labels used for similar items. However, flood illuminator 300 comprises an MOE 316 that differs from MOE 116 of flood illuminator 102: MOE 316 comprises optical zones 318a and 318b which convert beams 138a and 138b respectively into cones 340a and 340b of flood illumination. These cones are rotated in opposite, respective directions by respective optical zones 318a and 318b toward an optical axis 308 of illuminator 300: Cone 340a is rotated clockwise toward the optical axis and cone 340b is rotated counterclockwise toward the optical axis. Cone 340a is delineated by arrows 342a and 344a, and cone 340b is delineated by arrows 342b and 344b. A rotation of this sort may be useful in reducing the footprint of flood illumination on display panel 106 (FIG. 1), as well as increasing the overlap between the cones in some distance ranges.

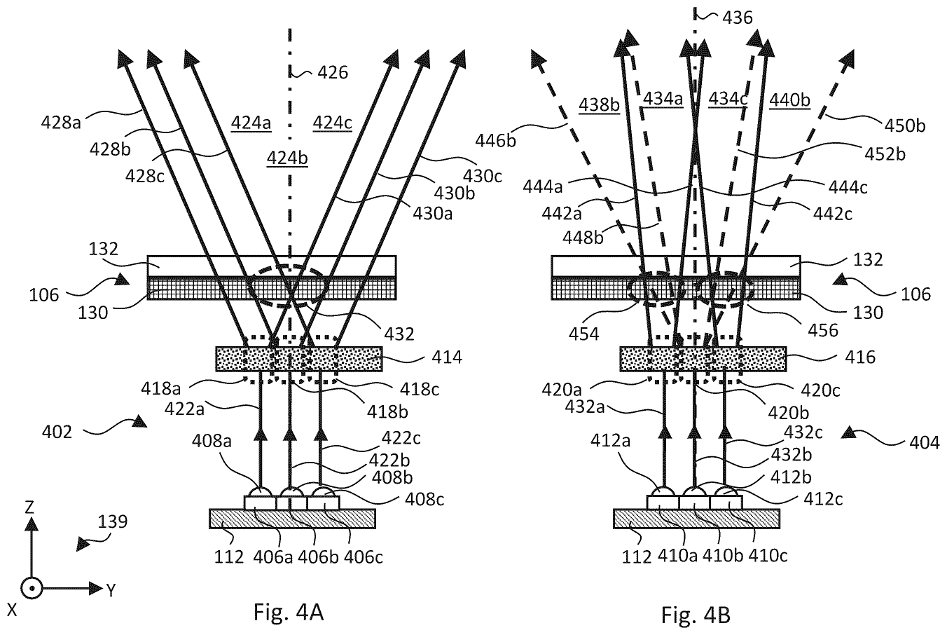

FIGS. 4A and 4B are respective schematic sectional views of two flood illuminators 402 and 404, in accordance with embodiments of the invention. Either of these flood illuminators may be used in place of the flood illuminators shown in the preceding figures.

The sectional views of FIGS. 4A and 4B are shown across the YZ-plane of Cartesian coordinates 139, i.e., perpendicularly to the sectional views of FIGS. 1-3, which are shown across the XZ-plane. Cartesian coordinates 139 are used in the present description only for the purpose of comparing the orientations of the sectional views and may be rotated without affecting the generality of the description. Items in FIGS. 4A and 4B that are similar to items in FIGS. 1-3 are labelled with the same labels.

Both flood illuminators 402 and 404 comprise an array of VCSELs with typically tens to hundreds of VCSELs, of which only three are depicted in the Y-direction. (In alternative embodiments, the illuminators may comprise fewer or more than three emitters in the Y-direction.) Illuminator 402 comprises three VCSELs 406a, 406b and 406c on substrate 112, with respective microlenses 408a, 408b and 408c disposed on the VCSELs. Illuminator 404 comprises three VCSELs 410a, 410b and 410c on substrate 112, with respective microlenses 412a, 412b and 412c disposed on the VCSELs.

Flood illuminators 402 and 404 comprise respective MOEs 414 and 416. MOE 414 comprises three distinct optical zones 418a, 418b and 418c, aligned respectively with VCSELs 406a, 406b and 406c. MOE 416 comprises three distinct optical zones 420a, 420b and 420c, aligned respectively with VCSELs 410a, 410b and 410c.

Flood illuminator 402 generates flood illumination on a target region (not shown in the figure) by driving the VCSELs in its VCSEL array. VCSELs 406a, 406b and 406c emit respective beams 422a, 422b and 422c of optical radiation in the Z-direction toward respective optical zones 418a, 418b and 418c of MOE 414, with the beams shown as chief rays of the respective VCSELs. These optical zones convert beams 422a, 422b and 422c into identical overlapping cones 424a, 424b and 424c of optical radiation. Cone 424a is delineated by arrows 428a and 430a, cone 424b is delineated by arrows 428b and 430b, and cone 424c is delineated by arrows 428c and 430c. The concentration of cones 424a, 424b and 424c around optical axis 426 generates a central hotspot 432 on display panel 130, which may heat the panel and damage it.

The design of flood illuminator 404 alleviates the problem of a centralized hotspot by spreading the illumination across display panel 130. For this purpose, optical zones 420a, 420b and 420c of MOE 417 apply different degrees of divergence to the optical radiation applied by VCSELs 410a, 410b and 410c. FIG. 4B show one example of this sort of scheme, but alternatively, other schemes for applying different degrees of divergence to the radiation emitted by different VCSELs will be apparent to those skilled in the art after reading the present disclosure and are considered to be within the scope of the present disclosure.

In the specific embodiment shown in FIG. 4B, when VCSELs 410a, 410b and 410c of flood illuminator 404 are driven, they emit respective beams 432a, 432b and 432c of optical radiation in the Z-direction toward respective optical zones 420a, 420b and 420c of MOE 416, with the beams shown as chief rays of the respective VCSELs, similarly to illuminator 402. Zones 420a and 420c convert respective beams 432a and 432c into narrow cones 434a and 434c of optical radiation, which propagate in the Z-direction symmetrically around an optical axis 436 of illuminator 404. Cone 434a is delineated by solid arrows 442a and 444a, and cone 434c is delineated by solid arrows 442c and 444c. Zone 420b functions differently from zones 420a and 420c: It converts and splits beam 432b into two narrow cones 438b and 440b, which are tilted symmetrically away from axis 436. Cone 438b is delineated by dashed arrows 446b and 448b, and cone 440b is delineated by dashed arrows 450b and 452b. Due to the widths and orientations of cones 434a, 434c, 438b and 440b, the flood illumination emitted by illuminator 404 generates two hotspots 454 and 456 on display panel 130, wherein each of the hotspots has a lower optical intensity than hotspot 432 in FIG. 4A, thus lowering the potential for damage or flickering of the display panel.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An illumination projector, comprising:
at least first and second emitters configured to emit respective first and second beams of coherent optical radiation at different, respective first and second wavelengths; and
projection optics mounted over the at least first and second emitters and configured to combine the first and second beams into a cone of flood illumination having an angular extent of at least 30°.

2. The illumination projector according to claim 1, wherein the at least two different wavelengths differ by an amount exceeding 3 nm.

3. The illumination projector according to claim 1, wherein each of the first and second emitters comprises at least one vertical-cavity surface-emitting laser (VCSEL).

4. The illumination projector according to claim 3, and comprising a microlens disposed over each VCSEL.

5. The illumination projector according to claim 3, wherein the first and second emitters comprise respective first and second pluralities of VCSELs, and wherein the projection optics are configured to apply different degrees of divergence to the coherent optical radiation emitted by the VCSELs in each of the first and second pluralities.

6. The illumination projector according to claim 1, wherein the projection optics comprise at least one metasurface optical element (MOE).

7. The illumination projector according to claim 6, wherein the at least one MOE is configured to apply different, respective tilt angles to the first and second beams.

8. The illumination projector according to claim 6, wherein the at least one MOE comprises a single MOE having respective first and second optical zones for receiving the first and second beams.

9. The illumination projector according to claim 1, wherein the projection optics comprise at least one diffractive optical element (DOE).

10. The illumination projector according to claim 1, and comprising:
at least a third emitter positioned adjacent to the first and second emitters and configured to emit a third beam of coherent radiation; and
beamsplitting optics configured to split the third beam into a pattern of structured light distributed across at least a part of the angular extent.

11. The illumination projector according to claim 10, wherein the beamsplitting optics and the projection optics are implemented in distinct, respective optical zones of a metasurface optical element (MOE).

12. An optical system, comprising:
the illumination projector according to claim 1, configured to project the flood illumination onto a field of view; and
a camera positioned alongside the illumination projector and configured to capture images of the field of view under the flood illumination.

13. The optical system according to claim 12, and comprising a display panel, which is transparent at the first and second wavelengths, wherein the illumination projector and the camera are positioned behind the display panel so that the flood illumination is projected toward the field of view and the images of the field of view are captured through the display panel.

14. A method for illumination, comprising:
driving at least first and second emitters to emit respective first and second beams of coherent optical radiation at different, respective first and second wavelengths; and
combining and projecting the first and second beams into a cone of flood illumination having an angular extent of at least 30°.

15. The method according to claim 14, wherein the at least two different wavelengths differ by an amount exceeding 3 nm.

16. The method according to claim 14, wherein combining and projecting the first and second beams comprises applying at least one metasurface optical element (MOE) to project the first and second beams into a cone of flood illumination.

17. The method according to claim 16, wherein applying the at least one MOE comprises directing the first and second beams into the cone at different, respective tilt angles.

18. The method according to claim 14, and comprising driving at least a third emitter, positioned adjacent to the first and second emitters, to emit a third beam of coherent radiation, and splitting the third beam into a pattern of structured light distributed across at least a part of the angular extent.

19. The method according to claim 14, and comprising capturing images of a field of view illuminated by the flood illumination.

20. The method according to claim 19, and comprising presenting a display on a display panel, which is transparent at the first and second wavelengths, wherein the flood illumination is projected toward the field of view and the images of the field of view are captured through the display panel.
